(19) United States
(12) Patent Application Publication
(10) Pub. No.: US 2022/0318558 A1
(43) Pub. Date: Oct. 6, 2022

(54) LANE-LEVEL NAVIGATION METHOD AND SYSTEM INCORPORATING ADAS FINE-SENSORY DATA

(71) Applicant: WUHAN UNIVERSITY OF TECHNOLOGY, HUBEI (CN)

(72) Inventors: NENGCHAO LV, Hubei (CN); JINJIN GAO, Hubei (CN); YUGANG WANG, Hubei (CN); CHAOZHONG WU, Hubei (CN)

(73) Assignee: WUHAN UNIVERSITY OF TECHNOLOGY, HUBEI (CN)

(21) Appl. No.: 17/517,651

(22) Filed: Nov. 2, 2021

(30) Foreign Application Priority Data
Mar. 30, 2021 (CN) 202110337888.8

(51) Int. Cl. G06K 9/00; G01C 21/36; G06K 9/46

(52) U.S. Cl. CPC G06K 9/00798; G01C 21/3673; G06K 9/4604

(57) ABSTRACT

The disclosure provides a lane-level navigation method and system incorporating ADAS fine-sensory data, which comprises the following steps: collecting the real-time road images in front of the vehicle, and pretreating the real-time road images which are collected; extracting lane feature points and determining lane information from the preprocessed images; extracting feature points and contour edge lines of road signs in the lane area where the vehicle is located in the preprocessed images, and combining with lane signs to generate lane sign feature point information; identifying and outputting the corresponding lane number and lane function, and transmitting recognized information to the vehicle navigation center control platform, or transmitting to a mobile terminal navigation APP; generating automatic navigation instructions to provide a driver with precise lane-level movements. By effectively fusing ADAS data, the method of the present invention has the advantages of low cost, good compatibility.

### CROSS-REFERENCE TO RELATED APPLICATION

This application claims the priority benefit of China application serial no. 202110337888.8, filed on Mar. 30, 2021. The entirety of the above-mentioned patent application is hereby incorporated by reference herein and made a part of this specification.

### BACKGROUND

### Technical Field

The invention relates to the field of intelligent vehicle navigation, in particular to a lane-level navigation method and system incorporating ADAS fine sensory data.

### Description of Related Art

With the development of the national economy and the improvement of people's living standards, the number of registered vehicles has increased dramatically, and with it the demand for traffic information has also increased day by day, all kinds of car navigation products have gradually come into people's view.

Throughout the development of the automobile navigation market, the automobile navigation products have basically realized the vehicle self-localization and map matching, the route planning, navigation, the road information inquiry and so on, but the navigation industry still faces many difficulties, for example: real-time dynamic information exchange capacity is insufficient, the current vehicle navigation system can only passively receive GPS satellite signals, and cannot interact with outside information combined with pre-installed electronic maps in real time, and on this basis, there is also the problem of low navigation accuracy. At present, various navigation systems cannot achieve the accuracy of the lane level in navigation accuracy, or the existing navigation system have to rely on high-precision electronic maps to be completed, which increases the cost of navigation and reduces the feasibility of the technology.

### SUMMARY

In order to solve the problems of low navigation accuracy and high operation cost in the existing navigation technology, the invention provides a method and a system for achieving lane-level positioning and lane functional navigation by using ADAS system to collect auxiliary information.

The technical scheme adopted by the invention is as follows:

a lane-level navigation method incorporating ADAS fine-sensory data includes the following steps:

step S1: collecting the real-time road image of the front of the vehicle, and preprocessing the collected image;

step S2: extracting lane feature points and determining lane information, wherein the lane information includes lane line number, lane position and lane type;

step S3: extracting feature points and contour edge lines of road signs in a lane area of the vehicle in the preprocessed images, combining with lane signs, and extracting rules to generate lane sign feature point information;

step S4: identifying and outputting the lane line number and a lane function according to the lane line number, the lane position, the lane type, lane sign feature point information and a preset lane number and preset lane indicator function numbering rules;

step S5: transmitting the recognized lane line number, lane function, forward vehicle information automatically acquired by ADAS module and the longitude and latitude information of the vehicle to the vehicle navigation center control platform, or to the mobile terminal navigation APP;

step S6: the navigation module generates automatic navigation instructions according to the received standardized vehicle lane position, lane function, which are combined with forward vehicle information and the vehicle's latitude and longitude information, so as to provide drivers with an accurate lane level movement guidance.

In the lane-level navigation method of an embodiment of the invention, in the step S1, the monocular camera installed on the front windshield of the vehicle is used to capture a real-time road image of the front of the vehicle.

In the lane-level navigation method of an embodiment of the invention, the lane line information in step S2 further include the current lane position information of the vehicle.

In the lane-level navigation method of an embodiment of the invention, in step S4, the position, number and type of lane lines, as well as a lane sign feature point information of lane indicating signs are matched with the preset lane number and a lane indicating sign functions, identify the lane line number and lane function information of the current vehicle.

In the lane-level navigation method of an embodiment of the invention, in the step S5, the identified vehicle number, lane function, forward vehicle information obtained by ADAS module, longitude and latitude information of the vehicle, longitudinal distance and relative speed information of adjacent vehicles in front of each lane are transmitted to the vehicle navigation center console through CAN bus or to the mobile terminal navigation APP through WIFI or Bluetooth.

The invention also provides a lane-level navigation system incorporating ADAS fine-sensory data, which comprises an ADAS module, a data processing module, a data interaction module and a navigation module.

Wherein, the ADAS module comprises:

the image acquisition module, which is used for collecting the real-time road scene image of the front of the vehicle;

the image pre-processing module, which is used for pretreating the collected image;

lane line extraction module, which is used to detect lane line in pre-processed image. lane line feature points and lane line information, including lane line number, lane line position and lane type;

lane sign extraction module, which is used to extract the feature points and contour edge lines of the road sign in the lane area of the vehicle in the pre-processed image, and to generate lane sign feature points based on lane sign extraction rules;

a data processing module, which is used for combining the preset lane number and lane indication sign function number rules according to the lane line number, position, type and lane indication sign feature point information, identify and output lane line numbers and lane functions;

the data interactive module, which is used for transmitting the recognized lane line number, lane function, the forward vehicle information and the vehicle longitude and latitude information obtained automatically by the ADAS module to the vehicle navigation center control platform, or to the mobile terminal navigation APP; and

the navigation module, which is used for generating automatic navigation instructions according to the received standardized vehicle lane position, lane function, combined with forward vehicle information and the vehicle longitude and latitude information, provide accurate lane level movement guidance to drivers.

In the lane-level navigation system of an embodiment of the invention, the image acquisition module, which is a monocular camera installed on the front windshield of the vehicle.

In the lane-level navigation system of an embodiment of the invention, the data processing module, which matching the number and position of lane lines with the rules of lane line numbering in turn from left to right to obtain the lane line number of the vehicle, the lane indicator feature point information is matched with the lane indicator number rule to match the lane output function.

In the lane-level navigation system of an embodiment of the invention, the data interaction module connects the ADAS module with the vehicle navigation center console through a CAN bus or a WIFI form, and the ADAS module is connected with the navigation APP of the mobile terminal through WIFI or Bluetooth.

The invention also provides a computer storage medium in which a computer program is stored and can be executed by a processor, the computer program performs a lane-level navigation method incorporating ADAS fine sensing data as described in the technical scheme.

The invention has the advantages that: the invention processes the image through the camera device installed on the ADAS vehicle, the lane line extraction module and the lane indication sign extraction module of the ADAS system, lane information and lane sign information are extracted, then lane line number and function are obtained, then navigation information is transmitted through CAN bus, WIFI or Bluetooth, it can locate the lane level and realize the navigation of lane function. The method of the invention can provide more accurate navigation based on lane lines and lane functions, and can provide more precise lane-level movement guidance for drivers without combining high-precision maps, thus making the navigation system more humanized.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a lane-level navigation method incorporating advanced driver assistance system (ADAS) fine-sensory data according to an embodiment of the invention.

FIG. 2 is a schematic diagram illustrating a lane-level navigation system incorporating ADAS fine-sensory data according to an embodiment of the invention.

### DESCRIPTION OF THE EMBODIMENTS

In order to make the purposes, technical scheme and advantages of the invention more clear, the invention is further explained in detail in combination with the attached drawing and the embodiment. It should be understood that the specific embodiments described herein are used only to explain the invention and not to qualify it.

Based on the function of vehicle ADAS, the invention provides a lane-level navigation method which fuses ADAS fine-sensory data. The method can realize the fusion of forward sensing target and existing vehicle navigation system by effectively fusing ADAS data, it has the advantages of low cost and good compatibility, and can effectively solve the problem of low accuracy of lane positioning in vehicle navigation technology. In particular, the invention adds the functions of image acquisition, image processing and image recognition to the existing ADAS system to realize real-time lane level and high-precision navigation of lane function, no need of high-precision electronic map can achieve lane-level positioning and lane function of high-precision navigation, can provide more sophisticated lane-level guidance, not only make navigation system more humane, but also reduce the cost requirements.

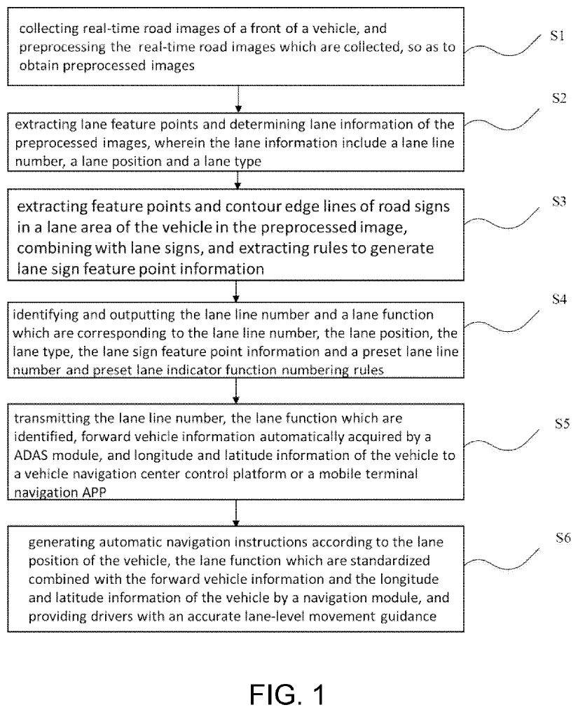

As shown in FIG. 1, a lane-level navigation method for incorporating ADAS fine-sensory data includes the following steps:

Step S1: real-time images of the road ahead are collected during the vehicle is moving, and it preprocesses the real-time images which are collected is preprocessed, so as to obtain preprocessed images.

It needs to be explained that the camera mounted on the front windshield can be used for image acquisition. The collected image is mainly the front lane information of the vehicle. The image pre-processing is mainly to gray the original image, image enhancement and image filtering.

Step S2: the lane line feature points are extracted by a lane line extraction module, and the lane line number, lane position and lane type are obtained.

It needs to be explained that the lane line extraction module mainly obtains lane line number, lane position, lane Type (including lane's true and false, single and double, color, etc.) and lane area position, etc.

Step S3: Feature points and edge lines of road signs are extracted by a lane signs extraction module, and feature points information of lane signs is obtained from rules according to lane signs.

Step S4: The lane line number and lane function can be obtained by matching the lane information extracted from the step S2 and the step S3 with the lane number and a lane sign rules.

It needs to be explained that the original straight, left, right, straight left, straight right, straight right, left turn, left turn, left turn, bus lane, and so on are numbered respectively. The default lane line numbering rules can be left to right numbered 123 . . . , the lane indicator setting rules are straight 1, left turn 2, Right Turn 3, Straight Left Turn 4, Straight Right Turn 5, left turn 6, straight ahead, left turn, seven, bus lane eight.

Step S5: the vehicle lane line number, lane function and other information are sent to the navigation module through the data interaction module;

It needs to be explained that the data interaction module mainly carries on the data interaction through CAN bus, WIFI and Bluetooth three kinds of forms, through CAN bus the ADAS system CAN be connected with the vehicle navigation center control platform, connecting ADAS to a mobile navigation APP via WIFI or Bluetooth allows for real-time and efficient navigation data exchange.

Step S6: The navigation module combines the lane line number and function information with the forward vehicle information and the vehicle position information obtained by ADAS module to provide the accurate lane-level navigation information for the driver.

It needs to be explained that the forward vehicle information includes information such as the distance between the vehicle and the vehicle in front, the relative speed, and the latitude and longitude information obtained from the vehicle's positioning module (GPS or Beidou Satellite), to make precise navigation decisions at the lane level. It is mainly based on the information of the forward vehicles to judge whether it is safe to change lanes to other lanes, for example, when the driver needs to change lanes near a turning junction or a high-speed ramp, it is suggested that the driver can press the lane and whether he needs to change lanes, and the ability to change lanes.

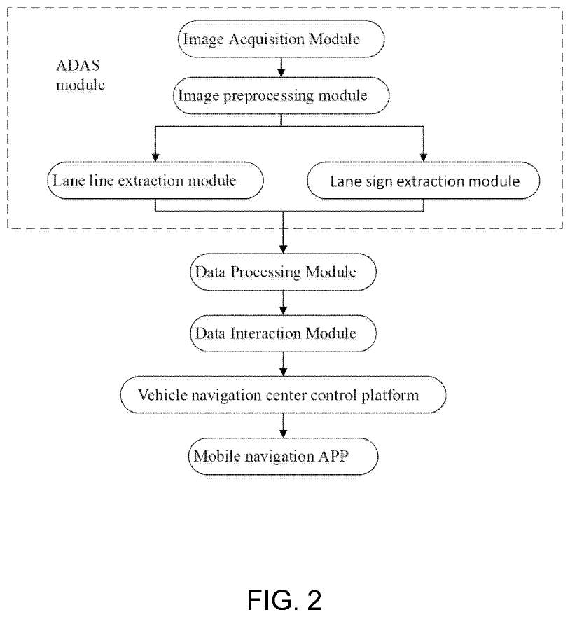

As shown in FIG. 2, a lane-level navigation system incorporating ADAS fine sensing data comprises an ADAS module, a data processing module, a data interaction module and a navigation module.

ADAS module, used for image acquisition, image processing and image recognition, mainly extract the lane information in the image and identify, and obtain with each lane in front of the adjacent vehicle longitudinal distance, relative speed and the car latitude and longitude and so on.

The ADAS module not only has the functions of the original ADAS system, but also includes image acquisition module, image preprocessing module, lane line extraction module, Lane indication and sign extraction module.

Among them:

the image acquisition module is used for collecting the real-time image of the road ahead of the vehicle, and the image acquisition module is a monocular camera;

the image pre-processing module is used for pre-processing the collected vehicle front road image;

the lane line extraction module is used to extract lane feature points, output lane feature points information, and determine lane line number, lane position and lane type;

the lane indicator extraction module is used to extract the feature points and contour edge lines of lane indicator marks in lane area, calculate the coordinate of feature points of marking lines, and generate the information of traffic marking feature points.

The data processing module is used to match the lane line number and lane position with the lane line number to get the lane line number information It is also used to match the lane indicator feature point information with the lane indicator function setting rules, and to calculate the lane function of the vehicle location.

The data interactive module is used to transmit lane line number, lane function and lane line information to vehicle navigation center platform through CAN bus, or to mobile terminal navigation APP through WIFI or Bluetooth.

The navigation module is used to receive lane line numbers and lane functions, and provides accurate lane-level navigation information by combining the distance, relative speed, and latitude and longitude information obtained by ADAS, the navigation module that can be supported includes vehicle navigation center platform and mobile terminal navigation APP. Mobile terminals can be hand-held devices such as mobile phones and tablets.

In summary, the invention collects the road image in front of the vehicle through the camera on the ADAS vehicle, extracts the lane line and lane indication sign information by using the image processing module, and then obtains the lane line number and lane function of the vehicle, then the information is transmitted to the navigation module through the data interaction module. The navigation module combines the forward vehicle information acquired by the ADAS module with the longitude and latitude information of the vehicle to make the lane-level navigation service with high precision. Compared with the prior art, the invention can also interact the acquired information in real time through CAN bus, WIFI and Bluetooth, and can realize lane-level high-precision navigation without the aid of high-precision map.

It should be understood that, for ordinary technicians in the field, improvements or transformations may be made on the basis of the above description, and that all such improvements and transformations shall fall within the protection of the claims annexed to the present invention.

What is claimed is:

1. A lane-level navigation method incorporating advanced driver assistance system (ADAS) fine-sensory data, wherein the lane-level navigation method comprises the following steps:
step S1: collecting real-time road images of a front of a vehicle, and preprocessing the real-time road images which are collected, so as to obtain preprocessed images;
step S2: extracting lane feature points and determining lane information of the preprocessed images, wherein the lane information include a lane line number, a lane position and a lane type;
step S3: extracting feature points and contour edge lines of road signs in a lane area of the vehicle in the preprocessed image, combining with lane signs, and extracting rules to generate lane sign feature point information;
step S4: identifying and outputting a lane number and a lane function corresponding to the lane line number, the lane position, the lane type, lane sign feature point information and a preset lane number and preset lane indicator function numbering rules;
step S5: transmitting the lane number, the lane function which are identified, forward vehicle information automatically acquired by a ADAS module, and longitude and latitude information of the vehicle to a vehicle navigation center control platform or a mobile terminal navigation APP;
step S6: generating automatic navigation instructions according to the lane position of the vehicle, the lane function which are standardized combined with the forward vehicle information and the longitude and latitude information of the vehicle by a navigation module, and providing drivers with an accurate lane-level movement guidance.

2. The lane-level navigation method according to claim 1, wherein in the step S1, a monocular camera mounted on a vehicle's front windshield is used to capture the real-time road image of the front of the vehicle.

3. The lane-level navigation method according to claim 1, wherein in the step S2, the lane information further includes a position information of a lane where the vehicle is currently located.

4. The lane-level navigation method according to claim 1, wherein in the step S4, by matching the lane position, the lane line number, the lane type and the lane sign feature point information with the preset lane number and a lane indicator function, so as to identify the lane number and a lane function information which are currently corresponding to the vehicle.

5. The lane-level navigation method according to claim 1, wherein in the step S5, the lane line number, the lane function which are identified, the forward vehicle information acquired by the ADAS module, the longitude and latitude information of the vehicle, a longitudinal distance, and relative speed information of adjacent vehicles in front of each of lanes are transmitted to the vehicle navigation center control platform through a CAN bus or transmitted to the mobile terminal navigation APP through WIFI or Bluetooth.

6. A lane-level navigation system incorporating ADAS fine-sensory data, wherein the lane-level navigation system includes an ADAS module, a data processing module, a data interaction module and a navigation module; wherein the ADAS module comprises:
an image acquisition module, which is used for collecting real-time road scene images of a front of a vehicle;
an image pre-processing module, which is used for pretreating the real-time road images which are collected, so as to obtain preprocessed images;
a lane line extraction module, which is used to detect lane line in the preprocessed images and to extract lane line feature points to determine lane line information, wherein the lane line information include a lane line number, lane line position and lane type;
a lane sign extraction module, which is used to extract feature points and contour edge lines of road signs in a lane area of the vehicle in the preprocessed images, and to generate lane sign feature point information based on combining lane signs and extracting rules;
wherein the data processing module is used for combining a preset lane number and preset lane indication sign function numbering rules according to the lane line number, the lane position, the lane type and the lane sign feature point information, identifying and outputting a lane number and a lane function;
wherein the data interactive module is used for transmitting the lane number, the lane function which are identified, forward vehicle information automatically acquired by the ADAS module and longitude and latitude information of the vehicle to a vehicle navigation center control platform, or to a mobile terminal navigation APP;
wherein the navigation module is used for generating automatic navigation instructions according to the lane position of the vehicle, the lane function which are standardized combined with the forward vehicle information and the longitude and latitude information of the vehicle, so as to provide an accurate lane level movement guidance to drivers.

7. The lane-level navigation system according to claim 6, wherein the image acquisition module is a monocular camera mounted on a front windshield of the vehicle.

8. The lane-level navigation system according to claim 6, wherein the data processing module arranges and matches the lane line number, the lane position, and lanes with a rule that the lanes are numbered sequentially from left to right to get the lane number where the vehicle is located, and matches the lane sign feature point information with indicating mark numbering rules to output the lane function.

9. The lane-level navigation system according to claim 6, wherein the data interaction module connects the ADAS module to the vehicle navigation center control platform through a CAN bus or WIFI, or connects the ADAS module to the mobile terminal navigation APP via WIFI or Bluetooth.

10. A computer storage medium, recording computer program to be loaded by a processor of a computer system to execute the lane-level navigation method of wherein the computer storage medium stores in the medium and can be executed by a processor, the computer program executes the lane-level navigation method of claim 1.
